(19) United States
(12) Patent Application Publication
(10) Pub. No.: US 2012/0151456 A1
(43) Pub. Date: Jun. 14, 2012

(54) LOW POWER PROGRAM COMPILING DEVICE, METHOD AND COMPUTER READABLE STORAGE MEDIUM FOR STORING THEREOF

(75) Inventors: Shen-Hung WANG, Kaohsiung City (TW); Yi-Ping YOU, Taichung City (TW); YI-Ting LIN, Kaohsiung City (TW); Ming-Yung KO, Taichung City (TW); Chia-Ming CHANG, New Taipei City (TW); Yu-Jung CHENG, Yilan County (TW)

(73) Assignee: INSTITUTE FOR INFORMATION INDUSTRY, Taipei (TW)

(21) Appl. No.: 13/030,139

(22) Filed: Feb. 18, 2011

(30) Foreign Application Priority Data
Dec. 10, 2010 (TW) 099143278

(51) Int. Cl. G06F 9/45

(52) U.S. Cl. 717/140

(57) ABSTRACT

A low power program compiling method includes the following steps: a program to be compiled is received. Wherein, the program includes several instructions to be compiled, the program is executed by an electrical device, which includes several candidate hardware units, after compiled. One of the candidate hardware units is selected as a target hardware unit. Several target hardware instructions, which access the target hardware unit, are detected from the instructions. The target hardware instructions are gathered into a hardware instruction block of the program. An enabling instruction for enabling the target hardware unit and a disabling instruction for disabling the target hardware are inserted before and after the hardware instruction block of the program respectively. The program is compiled after inserted to generate a compiled program.

### RELATED APPLICATIONS

This application claims priority to Taiwan Application Serial Number 099143278, filed Dec. 10, 2010, which is herein incorporated by reference.

### BACKGROUND

1. Technical Field

The present invention relates to a program compiling device, method and computer readable storage medium for storing thereof. More particularly, the present invention relates to a low power program compiling device, method and computer readable storage medium for storing thereof.

2. Description of Related Art

As technology develops, more and more people utilize electrical devices (portable electrical devices) in their daily life. Wherein, the common portable electrical devices include personal digital assistants (PDAs), mobile phones, smart phones etc. Most portable electrical devices are light-weighted and easy to carry. Besides, to satisfy different users, there are more and more functions developed.

Most portable electrical devices consume power from batteries, which may limit standby time of portable electrical devices. However, there is a need to extend standby time of portable electrical devices.

### SUMMARY

According to one embodiment of this invention, a low power program compiling method is provided. In the low power program compiling method, instructions of a program, which access the same hardware unit, are gathered into a hardware instruction block of the program. Instructions to enable and disable the hardware unit thereof are inserted before and after the hardware instruction block of the program to be executed by an electrical device after compiled. The low power program compiling method may take the form of a computer program product stored on a computer-readable storage medium having computer-readable instructions embodied in the medium. The low power program compiling method includes the following steps: a program to be compiled is received. Wherein, the program includes several instructions to be compiled, and the program after compiled is executed by an electrical device, and the electrical device includes several candidate hardware units. One of the candidate hardware units is selected as a target hardware unit. Several target hardware instructions, which access the target hardware unit, are detected from the instructions to be compiled. The target hardware instructions are gathered into a hardware instruction block of the program. An enabling instruction for enabling the target hardware unit is inserted before the hardware instruction block of the program, and a disabling instruction for disabling the target hardware is inserted after the hardware instruction block of the program. The program is compiled after inserted to generate a compiled program. The compiled program is executed utilizing the electrical device. Before executing the hardware instruction block of the compiled program, the electrical device executes the enabling instruction to enable the target hardware unit of the electrical device. The electrical device executes the disabling instruction to disable the target hardware unit of the electrical device until the hardware instruction block of the compiled program is not executed by the electrical device.

According to another embodiment of this invention, a low power program compiling device is provided. The low power program compiling device gathers instructions of a program, which access the same hardware unit, into a hardware instruction block of the program. The low power program compiling device inserts instructions to enable and disable the hardware unit thereof before and after the hardware instruction block of the program to provide an electrical device for execution after compiled. The low power program compiling device includes a processing unit. The processing unit includes a receiving module, a selecting module, a detecting module, a gathering module, an inserting module, a compiling module and an output module. The receiving module receives a program to be compiled. Wherein, the program includes several instructions to be compiled, the program after compiled is executed by an electrical device, and the electrical device includes several candidate hardware units. The selecting module selects one of the candidate hardware units as a target hardware unit. The detecting module detects several target hardware instructions, which access the target hardware unit, from the instructions to be compiled. The gathering module gathers the target hardware instructions into a hardware instruction block of the program. The inserting module inserts an enabling instruction for enabling the target hardware unit before the hardware instruction block of the program, and inserts a disabling instruction for disabling the target hardware after the hardware instruction block of the program. The compiling module compiles the program after inserted to generate a compiled program. The output module outputs the compiled program to the electrical device, such that the electrical device executes the compiled program. Wherein, the electrical device executes the enabling instruction to enable the target hardware unit of the electrical device before the electrical device executes the hardware instruction block of the compiled program. The electrical device executes the disabling instruction to disable the target hardware unit of the electrical device until the hardware instruction block of the compiled program is not executed by the electrical device.

Above all, the target hardware unit of the electrical device is enabled only before the execution of the corresponding hardware instruction block, and is disabled right after the execution of the corresponding hardware instruction block finished. Hence, the period, at which the target hardware unit is enabled, can be shortened and idle time of the target hardware unit can be reduced. In one embodiment of this invention, if the enabling instruction and the disabling instruction are utilized for enabling and disabling the power of the target hardware unit, the power consumption of the target hardware unit of the electrical device can be saved by reducing the enabled time of the target hardware unit. Besides, if a battery supplies the power of the electrical device, which executes the compiled program thereof, the electrical device can operate for a longer time. In addition, only the data dependency of the instructions corresponding to the target hardware would be checked, which can reduce the instruction number to be checked for data dependency. Hence, if one embodiment of this invention is applied for compiling and executing programs in real time, the electrical device applying thereof can consume less power and less computing resource. In other words, delay caused by lack of operation resource can be avoided when the electrical compiles and executes programs in real time.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a low power program compiling method according to one embodiment of this invention; and

FIG. 2 illustrates a block diagram of a driving assisting system according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

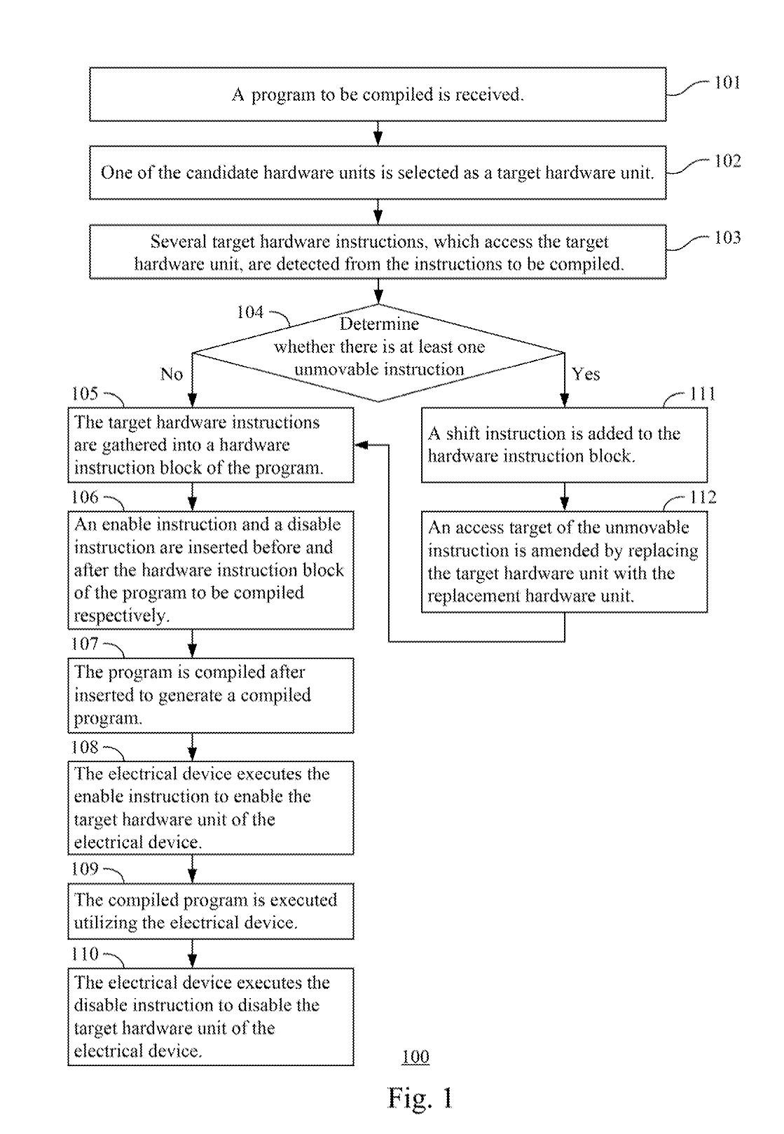

FIG. 1 is a flow diagram of a low power program compiling method according to one embodiment of this invention. In the low power program compiling method, instructions of a program, which access the same hardware unit, are gathered into a hardware instruction block of the program. Instructions to enable and disable the hardware unit thereof are inserted before and after the hardware instruction block of the program to be executed by an electrical device after compiled. The low power program compiling method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The low power program compiling method includes the following steps:

In step 101, a program to be compiled is received. Wherein, the program includes several instructions to be compiled. The program after compiled is executed by an electrical device. The electrical device includes several candidate hardware units.

In step 102, one of the candidate hardware units is selected as a target hardware unit. The target hardware unit selected in step 102 may be a memory module, an operating unit, a control unit, a wireless transmission unit or any other hardware unit.

In step 103, several target hardware instructions, which access the target hardware unit, are detected from the instructions to be compiled. Detection in step 103 may be executed by detecting the instructions to be compiled, which take the target hardware unit as accessing sources or destinations, as the target hardware instructions.

In step 105, the target hardware instructions are gathered into a hardware instruction block of the program. Wherein, in one embodiment of step 105, a consecutive block of the program may be taken as the hardware instruction block, and the target hardware instructions are moved to the hardware instruction block for gathering.

In step 106, an enabling instruction for enabling the target hardware unit is inserted before the hardware instruction block of the program, and a disabling instruction for disabling the target hardware is inserted after the hardware instruction block of the program. In one embodiment of this invention, the enabling instruction may enable the target hardware unit by powering on the target hardware unit, and the disabling instruction may disable the target hardware unit by powering off the target hardware unit. In other embodiments, the enabling instruction and the disabling instruction may enable and disable any other resource of the target hardware unit, which should not be limited in this disclosure.

In step 107, the program is compiled after inserted to generate a compiled program to provide the electrical device for execution.

In step 108, the electrical device executes the enabling instruction to enable the target hardware unit of the electrical device.

In step 109, after the enabling instruction is executed, the electrical device executes the target hardware instructions gathered in the hardware instruction block.

In step 110, until the hardware instruction block of the compiled program is not executed by the electrical device (step 109) is finished, the electrical device executes the disabling instruction to disable the target hardware unit of the electrical device. Therefore, the target hardware unit is enabled (step 107) only before the execution of the hardware instruction block (step 108), and is disabled right after the execution of the hardware instruction block (step 108) finished. Hence, the period, at which the target hardware unit is enabled, can be shortened and idle time of the target hardware unit can be reduced. In one embodiment of this invention, if the enabling instruction and the disabling instruction are utilized for enabling and disabling the power of the target hardware unit, the power consumption of the target hardware unit of the electrical device can be saved through reducing the enabled time of the target hardware unit.

In addition, the low power program compiling method 100 may further include step 104 to determine whether there is at least one unmovable instruction, which can not be moved to the hardware instruction block for gathering, among the target hardware instructions. In one embodiment of step 104, unmovable instruction determination of step 104 may be executed by determining whether there is at least one data-dependence instruction among the target hardware instructions. Wherein, the at least one data-dependence instruction is taken as the at least one unmovable instruction if there is the at least one data-dependence instruction.

If there is no unmovable instruction, the target hardware instructions are gathered (step 105). In step 111, if there is the unmovable instruction, a shift instruction, which is utilized for shifting data stored in the target hardware unit to a replacement hardware unit, is added to the hardware instruction block. In step 112, an access target of the unmovable instruction is amended through replacing the target hardware unit with the replacement hardware unit. Wherein, the replacement hardware unit may be a register, an embedded memory, a storage unit or other types of storage unit. Then, the program may be compiled through step 105-107. Therefore, even if the target hardware instruction with data dependency can not be moved, the access target of the target hardware instruction with data dependency can be amended to other hardware unit, such that the target hardware instruction with data dependency would not access the target hardware unit other than the execution of the hardware instruction block. In particular, if the hardware unit with faster accessing rate is taken as the replacement hardware unit, efficiency of the compiled program compiled after step 111 and step 112 may not be affected a lot. Besides, only the data dependency of the target hardware instructions would be checked, which can reduce the instruction number to be checked for data dependency. Hence, if the low power program compiling method 100 is applied for compiling and executing programs in real time, the electrical device applying thereof can consume less power and less computing resource. In other words, delay caused by lack of operation resource can be avoided when the electrical compiles and executes programs in real time.

In addition, before compiling the program (step 107), one of the other candidate hardware units is selected as the target hardware unit to execute step 103 to step 106 for the new-selected target hardware unit. Hence, some of the hardware units of the electrical device can be enabled only at the period executing corresponding hardware instruction blocks, which can further save the power consumption or the resource of the electrical device.

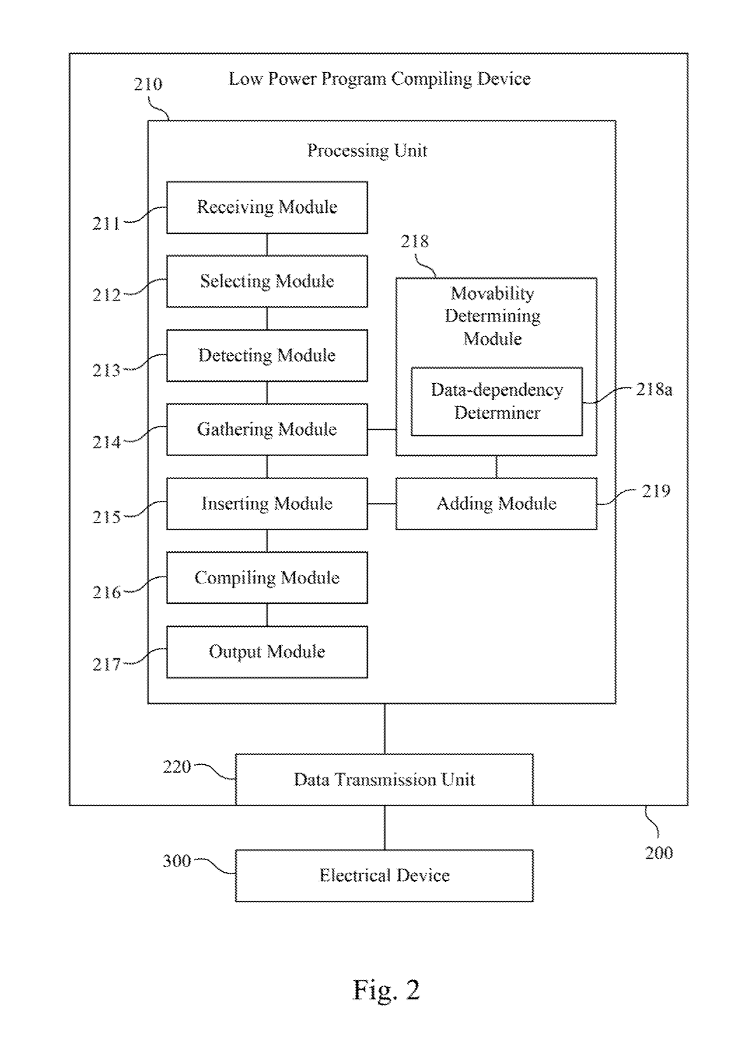

FIG. 2 illustrates a block diagram of a driving assisting system according to one embodiment of this invention. The low power program compiling device gathers instructions of a program, which access the same hardware unit, into a hardware instruction block of the program. The low power program compiling device respectively inserts instructions to enable and disable the hardware unit thereof before and after the hardware instruction block of the program to provide an electrical device for execution after compiled.

The low power program compiling device 200 includes a processing unit 210. The processing unit 210 includes a receiving module 211, a selecting module 212, a detecting module 213, a gathering module 214, an inserting module 215, a compiling module 216 and an output module 216.

The receiving module 211 receives a program to be compiled. Wherein, the program includes several instructions to be compiled. The program after compiled is executed by an electrical device. The electrical device includes several candidate hardware units.

The selecting module 212 selects one of the candidate hardware units as a target hardware unit. The selected target hardware unit may be a memory module, an operation unit, a control unit, a wireless transmission unit or any other hardware unit.

The detecting module 213 detects several target hardware instructions, which access the target hardware unit, from the instructions to be compiled. The detecting module 213 may detect the target hardware instructions according to the accessing sources or accessing destinations of the instructions to be compiled.

The gathering module 214 gathers the target hardware instructions into a hardware instruction block of the program. Wherein, the gathering module 214 may select a consecutive block of the program as the hardware instruction block. In addition, the gathering module 214 may move the target hardware instructions to the hardware instruction block for gathering.

The inserting module 215 inserts an enabling instruction for enabling the target hardware unit before the hardware instruction block of the program, and inserts a disabling instruction for disabling the target hardware after the hardware instruction block of the program. In one embodiment of this invention, the enabling instruction may enable the target hardware unit by powering on the target hardware unit, and the disabling instruction may disable the target hardware unit by powering off the target hardware unit. In other embodiments, the enabling instruction and the disabling instruction may enable and disable any other resource of the target hardware unit, which should not be limited in this disclosure.

The compiling module 216 compiles the program after inserted to generate a compiled program. The output module 217 outputs the compiled program to the electrical device. In one embodiment of this invention, the low power program compiling device 200 may be taken as the electrical device, which the output module 217 outputs the compiled program to. Hence, the processing unit 210 of the low power program compiling device 200 may execute the compiled program. In another embodiment of this invention, the output module 217 may output the compiled program to another electrical device 300 for execution through the data transmission unit 220. Wherein, the data transmission unit 220 is electrically connected to the processing unit 210. The data transmission unit 220 may transmit data utilizing wired or wireless data transmission protocols.

After the electrical device receives the compiled program, the electrical device can execute the compiled program. During the execution of the compiled program, the electrical device executes the enabling instruction to enable the target hardware unit of the electrical device before the electrical device executes the hardware instruction block of the compiled program. Until the hardware instruction block of the compiled program is not executed by the electrical device, the electrical device executes the disabling instruction to disable the target hardware unit of the electrical device. Therefore, the target hardware unit is enabled only before the execution of the hardware instruction block, and is disabled right after the execution of the hardware instruction block finished. Hence, the period, at which the target hardware unit is enabled, can be shortened and idle time of the target hardware unit can be reduced. In one embodiment of this invention, if the enabling instruction and the disabling instruction are utilized for enabling and disabling the power of the target hardware unit, the power consumption of the target hardware unit of the electrical device can be saved through reducing the enabled time of the target hardware unit.

Besides, during the compiling process, the low power program compiling device 200 may determine whether there is at least one unmovable instruction, which can not be moved to the hardware instruction block forgathering, among the target hardware instructions. Hence, the processing unit may further include a movability determining module 218 and an adding module 219. The movability determining module 218 determines whether there is at least one unmovable instruction, which can not be moved to the hardware instruction block for gathering, among the target hardware instructions. Wherein, the movability determining module 218 may determine at least one data-dependence instruction among the target hardware instructions as the at least one unmovable instruction.

If there is the unmovable instruction, the adding module 219 adds a shift instruction, which is utilized for shifting data stored in the target hardware unit to a replacement hardware unit, to the hardware instruction block. Besides, the adding module 219 amends an access target of the unmovable instruction through replacing the target hardware unit with the replacement hardware unit. Wherein, the replacement hardware unit may be a register, an embedded memory, a storage unit or other types of storage unit. Then, the compiling module 216 may compile the program after amended. Therefore, even if the target hardware instruction with data dependency can not be moved, the access target of the target hardware instruction with data dependency can be amended to other hardware unit, such that the target hardware instruction with data dependency after amended would not access the target hardware unit other than the execution of the hardware instruction block. In particular, if the hardware unit with faster accessing rate (such as a register) is taken as the replacement hardware unit, efficiency of the compiled program compiled may not be affected a lot. Besides, only the data dependency of the target hardware instructions would be checked, which can reduce the instruction number to be checked for data dependency. Hence, if the low power program compiling device 200 compiles and executes programs in real time, the low power program compiling device 200 can consume less power and less computing resource. In other words, delay caused by lack of operation resource of the low power program compiling device 200 can be avoided when compiling and executing programs in real time.

In addition, before the compiling module 216 compiles the program, the low power program compiling device 200 may select one of the other candidate hardware units of the electrical device as the target hardware unit for gathering other target hardware instructions corresponding to the new selected target hardware unit. Hence, some of the hardware units of the electrical device can be enabled only at the period executing corresponding hardware instruction blocks, which can further save the power consumption or the resource of the electrical device.

Above all, the target hardware unit of the electrical device is enabled only before the execution of the corresponding hardware instruction block, and is disabled right after the execution of the corresponding hardware instruction block finished. Hence, the period, at which the target hardware unit is enabled, can be shortened and idle time of the target hardware unit can be reduced. In one embodiment of this invention, if the enabling instruction and the disabling instruction are utilized for enabling and disabling the power of the target hardware unit, the power consumption of the target hardware unit of the electrical device can be saved through reducing the enabled time of the target hardware unit. Besides, if a battery supplies the power of the electrical device, which executes the compiled program thereof, the electrical device can operate for a longer time. In addition, only the data dependency of the instructions corresponding to the target hardware would be checked, which can reduce the instruction number to be checked for data dependency. Hence, if one embodiment of this invention is applied for compiling and executing programs in real time, the electrical device applying thereof can consume less power and less computing resource. In other words, delay caused by lack of operation resource can be avoided when the electrical compiles and executes programs in real time.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A low power program compiling method comprising:
receiving a program to be compiled, wherein the program comprises a plurality of instructions to be compiled, the program is executed by an electrical device after compiled, the electrical device comprises a plurality of candidate hardware units;
selecting one of the candidate hardware units as a target hardware unit;
detecting a plurality of target hardware instructions, which access the target hardware unit, from the instructions;
gathering the target hardware instructions into a hardware instruction block of the program;
inserting an enabling instruction for enabling the target hardware unit before the hardware instruction block of the program, and inserting a disabling instruction for disabling the target hardware after the hardware instruction block of the program;
compiling the program after inserted to generate a compiled program;
executing the compiled program utilizing the electrical device;
before executing the hardware instruction block of the compiled program, the electrical device executing the enabling instruction to enable the target hardware unit of the electrical device; and
the electrical device executing the disabling instruction to disable the target hardware unit of the electrical device until the hardware instruction block of the compiled program is not executed by the electrical device.

2. The low power program compiling method of claim 1 further comprising:
determining whether there is at least one unmovable instruction, which can not be moved to the hardware instruction block for gathering, among the target hardware instructions;
adding a shift instruction, which is utilized for shifting data stored in the target hardware unit to a replacement hardware unit, to the hardware instruction block if there is the unmovable instruction; and
amending an access target of the unmovable instruction through replacing the target hardware unit with the replacement hardware unit.

3. The low power program compiling method of claim 2, wherein the step of determining whether there is at least one unmovable instruction among the target hardware instructions comprising:
determining whether there is at least one data-dependence instruction among the target hardware instructions, wherein the at least one data-dependence instruction is taken as the at least one unmovable instruction if there is the at least one data-dependence instruction.

4. The low power program compiling method of claim 2, wherein the replacement hardware unit is a register, an embedded memory or a storage unit.

5. The low power program compiling method of claim 1 further comprising:
selecting one of the other candidate hardware units as the target hardware unit.

6. The low power program compiling method of claim 1, wherein the target hardware unit is a memory module, an operating unit, a control unit or a wireless transmission unit.

7. A computer readable storage medium with a computer program to execute a low power program compiling method, wherein the low power program compiling method comprises:
receiving a program to be compiled, wherein the program comprises a plurality of instructions to be compiled, the program is executed by an electrical device after compiled, the electrical device comprises a plurality of candidate hardware units;
selecting one of the candidate hardware units as a target hardware unit;
detecting a plurality of target hardware instructions, which access the target hardware unit, from the instructions to be compiled;
gathering the target hardware instructions into a hardware instruction block of the program;
inserting an enabling instruction for enabling the target hardware unit before the hardware instruction block of the program, and inserting a disabling instruction for disabling the target hardware after the hardware instruction block of the program respectively;
compiling the program after inserted to generate a compiled program;
executing the compiled program utilizing the electrical device;
before executing the hardware instruction block of the compiled program, the electrical device executing the enabling instruction to enable the target hardware unit of the electrical device; and
the electrical device executing the disabling instruction to disable the target hardware unit of the electrical device until the hardware instruction block of the compiled program is not executed by the electrical device.

8. A low power program compiling device comprising:
a processing unit comprising:
a receiving module for receiving a program to be compiled, wherein the program comprises a plurality of instructions to be compiled, the program is executed by an electrical device after compiled, the electrical device comprises a plurality of candidate hardware units;
a selecting module for selecting one of the candidate hardware units as a target hardware unit;
a detecting module for detecting a plurality of target hardware instructions, which access the target hardware unit, from the instructions ;
a gathering module for gathering the target hardware instructions into a hardware instruction block of the program;
an inserting module for inserting an enabling instruction for enabling the target hardware unit before the hardware instruction block of the program, and inserting a disabling instruction for disabling the target hardware after the hardware instruction block of the program respectively;
a compiling module for compiling the program after inserted to generate a compiled program; and
an output module for outputting the compiled program to the electrical device, such that the electrical device executes the compiled program,
wherein the electrical device executes the enabling instruction to enable the target hardware unit of the electrical device before the electrical device executes the hardware instruction block of the compiled program,
wherein the electrical device executes the disabling instruction to disable the target hardware unit of the electrical device until the hardware instruction block of the compiled program is not executed by the electrical device after the electrical device finishes executing the hardware instruction io block of the compiled program.

9. The low power program compiling device of claim 8, wherein the processing unit further comprises:
a movability determining module for determining whether there is at least one unmovable instruction, which can not be moved to the hardware instruction block for gathering, among the target hardware instructions; and
an adding module for adding a shift instruction, which is utilized for shifting data stored in the target hardware unit to a replacement hardware unit, to the hardware instruction block if there is the unmovable instruction, and for amending an access target of the unmovable instruction through replacing the target hardware unit with the replacement hardware unit.

10. The low power program compiling device of claim 9, wherein the movability determining module comprises:
a data-dependency determiner for determining whether there is at least one data-dependence instruction among the target hardware instructions, wherein the at least one data-dependence instruction is taken as the at least one unmovable instruction if there is the at least one data-dependence instruction.

11. The low power program compiling device of claim 9, wherein the replacement hardware unit is a register, an embedded memory or a storage unit.

12. The low power program compiling device of claim 8, wherein the low power program compiling device is the electrical device.

13. The low power program compiling device of claim 12 further comprising a memory module, an operating unit, a control unit or a wireless transmission unit to be taken as the target hardware unit.

14. The low power program compiling device of claim 8 further comprising:
a data transmission unit electrically connected to the processing unit, wherein the output module output the compiled program to the electrical device through the data transmission unit.
